(19) United States
(12) Patent Application Publication
(10) Pub. No.: US 2025/0178501 A1
(43) Pub. Date: Jun. 5, 2025

(54) SEAT ASSEMBLY, CUSHION, AND TOOL AND METHOD OF FORMING

(71) Applicant: Lear Corporation, Southfield, MI (US)

(72) Inventors: Eric REPKE, Milford, MI (US); Ibrahim VALENZUELA, Novi, MI (US); Curtis HUDSON, Macomb, MI (US); Lisa SWIKOSKI, West Bloomfield, MI (US); Joshua HALLOCK, Warren, MI (US)

(21) Appl. No.: 18/524,237

(22) Filed: Nov. 30, 2023

(51) Int. Cl. B60N 2/70

(52) U.S. Cl. CPC B60N 2/7017

(57) ABSTRACT

A method is provided with positioning a stranded mesh material blank and a flexible sheet into a tool assembly, heating and softening the blank and/or the sheet; circulating fluid through the tool assembly to move the flexible sheet towards the blank to form a stranded mesh material member, and removing the member from the tool assembly. A system is provided with a tool assembly, a fluid flow device, a heater, and a controller to provide fluid to the tool assembly to move the flexible sheet towards the stranded mesh material blank to form a stranded mesh material member. A vehicle interior component is provided with a stranded mesh material member and a flexible layer bonded to the surface of the member.

### TECHNICAL FIELD

Various embodiments relate to a tool and a method of forming a nonfoam cushion and associated seat assembly, and a nonfoam cushion and a seat assembly.

### BRIEF DESCRIPTION OF THE DRAWINGS

FIG. 1 illustrates a perspective view of a seat assembly according to an embodiment;

FIG. 2 illustrates a partial view a cushion member according to an embodiment and for use with the seat assembly of FIG. 1, and with an optional skin according to another embodiment;

FIG. 3 illustrates a schematic view of a system according to an embodiment;

FIGS. 4A, 4B, and 4C illustrate a schematic views of a system according to an embodiment;

FIGS. 5A, 5B, and 5C illustrate a schematic views of a system according to an embodiment; and

FIGS. 6A and 6B illustrate a schematic views of a system according to an embodiment.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It is to be understood that the disclosed embodiments are merely exemplary and that various and alternative forms are possible. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ embodiments according to the disclosure.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

The terminology controller may be provided as one or more controllers or control modules for the various components and systems. The controller and control system may include any number of controllers, and may be integrated into a single controller, or have various modules. Some or all of the controllers may be connected by a controller area network (CAN) or other system. It is recognized that any controller, circuit, or other electrical device disclosed herein may include any number of microprocessors, integrated circuits, memory devices (e.g., FLASH, random access memory (RAM), read only memory (ROM), electrically programmable read only memory (EPROM), electrically erasable programmable read only memory (EEPROM), or other suitable variants thereof) and software which co-act with one another to perform operation(s) disclosed herein. In addition, any one or more of the electrical devices as disclosed herein may be configured to execute a computer-program that is embodied in a non-transitory computer readable medium that is programmed to perform any number of the functions as disclosed herein.

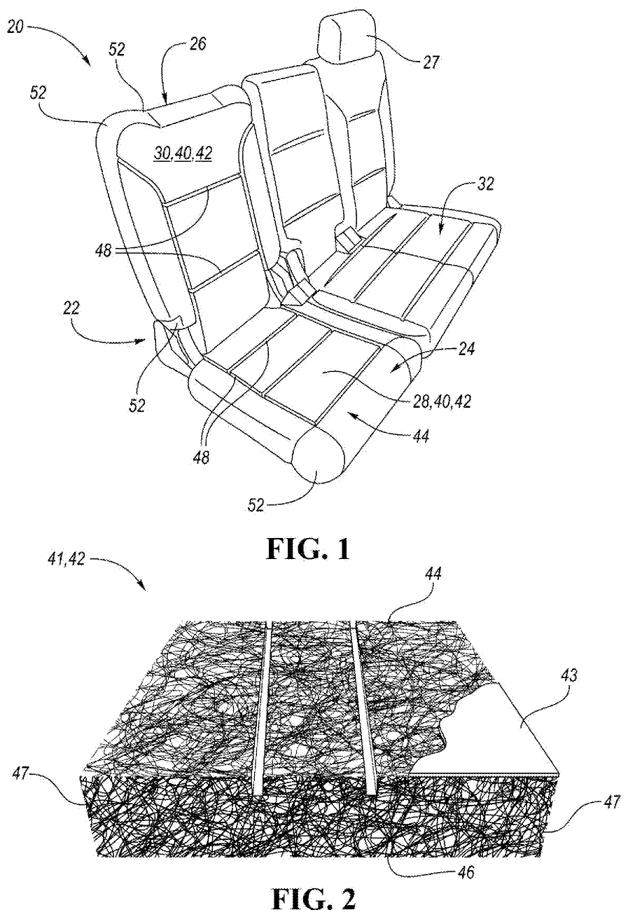

Referring to FIG. 1, a seat assembly 20, such as a vehicle seat assembly 20 is illustrated. In other examples, the seat assembly 20 may be shaped and sized as a front row driver or passenger seat, a second, third, or other rear row seat, and may include bench-style seats as shown, bucket seats, or other seat styles. Furthermore, the seat assembly may be a non-stowable seat or a stowable seat that may be foldable and stowable in a cavity in the vehicle floor. Additionally, the seat assembly 20 may be configured for use with other non-vehicle applications.

The seat assembly 20 has a frame 22 or other support structure. The seat assembly has seat components, and these seat components include at least a seat bottom 24 and a seat back 26. The seat bottom 24 may be sized to receive a seated occupant to support a pelvis and thighs of the occupant. The seat back 26 may be sized to extend upright from the seat bottom 24 to support a back of the occupant. The seat assembly may additionally have a head restraint 27, with the head restraint 27 illustrated for an adjacent seat assembly only. The seat bottom 24 has a seat bottom cushion 28. The seat back 26 has a seat back cushion 30. The frame 22 may include wire suspension mats or other structure to support the cushions 28, 30.

The frame 22 provides rigid structural support for the seat components, e.g. the seat bottom 24 and seat back 26, and may be provided as multiple frame members that are moveable relative to one another to provide adjustments for the seat assembly. The frame may be formed from a stamped steel alloy, a fiber reinforced polymer, or any suitable structural material. The frame 22 may further include a substrate, e.g. a panel, to support the associated cushion.

One or more trim covers 32 are used to cover the seat bottom cushion 28 and the seat back cushion 30, and provide a seating surface for the seat assembly 20. The vehicle seat assembly 20 is shown without a trim cover, and the adjacent seat assembly illustrates the trim cover 32. In one example, the trim cover 32 covers both of the cushions 28, 30. In other examples, multiple trim covers are provided to cover the seat bottom cushion and the seat back cushion. The trim cover 32 may be formed from one or more panels of a fabric, leather, leatherette, vinyl, or other material.

A seating cushion 40 is described in further detail below, and the description may similarly be applied to the seat bottom cushion 28 or the seat back cushion 30. The seating cushion 40 as described herein may additionally be used for other seating components, or for other vehicle interior components.

In the example shown, the seating cushion 40 includes at least one nonfoam component or member 42. In one example, and as shown, the seating cushion 40 is formed solely from the nonfoam component 42, such that the nonfoam component 42 provides all of the cushioning for the seat component between the frame 22 and the trim cover 32. In other examples, the seating cushion 40 may be formed from a nonfoam component 42 as well as one or more foam components, such as a component formed from molded polyurethane foam, or other nonfoam components. The seating cushion 40 may have the nonfoam and foam components positioned to provide different regions of the cushion 40 for the seating component, e.g. a central region, and side bolster regions. By removing some or all of the traditional foam from the seating cushion 40, the seat assembly 20 may be provided with improved support and comfort, and reduced weight.

In one non-limiting example, the nonfoam component or member 42 of the seating cushion 40 is formed by a stranded mesh material, also known as an entangled three-dimensional filament structure. The stranded-mesh material is made from a polymeric mesh having a plurality of integrated polymeric strands. The stranded-mesh material may be made from, for example, a linear low density polyethylene (LLDPE) material, although other polymers and materials effective to provide the desired properties and functionality are contemplated. The stranded-mesh material may be formed using extruded filaments of linear low-density polyethylene (LLDPE) that are randomly entangled, bent, looped, or otherwise positioned and oriented, and directly bonded to each other to provide a porous mesh structure, an example of which is shown in a closer view in FIG. 2.

The nonfoam component or member 42 may then be covered with a trim cover as described above. Alternatively, the cushion or interior component 40 may be formed, as described below, with one or more skins or integrated skins 43, such that a trim cover is not used, or is placed over the skin. In other examples, the cushion or interior component has a skin bonded or provided on one side or on more than one side. Each skin may be continuous, e.g. as a solid panel or sheet, or may be provided with one or more apertures, such as slit, holes, or the like. The skin 43 may provide an outer cover layer for the member 42 (e.g. in place of or in addition to a trim cover), and/or may act to limit or control air or fluid flow across the skin and through the member 42 across one, more than one, or all sides of the member 42.

Referring to FIG. 2, the cushion may be formed from a cushion blank 41, or stranded mesh material blank 41, of a stranded-mesh material member 42 that includes a first surface 44 and a second surface 46 positioned opposite to the first surface 44. Side surfaces 47, or edges, extend between the first and second surfaces 44, 46. The first surface 44 may be positioned on the seat assembly 20 to support an occupant of the seat assembly. The various surfaces 44, 46, 47 may be formed from a cushion blank via a system as described below, and may include various features such as recesses, trenches, channels, concave or convex surfaces, or other contours on the surfaces 44, 46, 47, or at the intersection of associated surfaces 44, 46, 47.

The cushion blank 41 may be formed from a consolidated filament structure that provides the stranded mesh material from which the cushion 40 and member 42 as described above is formed. Material stock such as solid granules or pellets of a plastic, such as a linear low-density polyethylene (LLDPE) may be fed from a hopper to an extruder. The extruder melts the material stock and transports it through a die plate. The material exits the extruder under pressure and in a molten state. The die plate extrudes the material into filaments via multiple small circular through holes or apertures through which the molten material passes such that a single filament is extruded from each die plate hole. The filaments fall from the die plate to a funnel to help consolidate or group the filaments into a more compact arrangement in which the filaments bend or loop and each filament contacts and bonds to at least one other filament. The consolidated filament structure then enters a fluid bath, such as a liquid tank to help temporarily support the consolidated filament structure, maintain the porosity and density, and cools the filaments from the outside to solidify them. The tank may be provided with various rollers and conveyors, and the consolidated filament structure may be cut to a desired sized and shape to form a cushion blank, e.g. using a cutting wheel, a water jet, or another technique. In one non-limiting example, the cushion blank 41 is provided as a generally rectangular prism.

The cushion blank 41 may be further cut prior to use with the system as described below. In some embodiments, the cushion blank 41 may be cut to a near-net shape based on the desired shape and size of the cushion 40, as well as the desired localized density properties of the cushion 40.

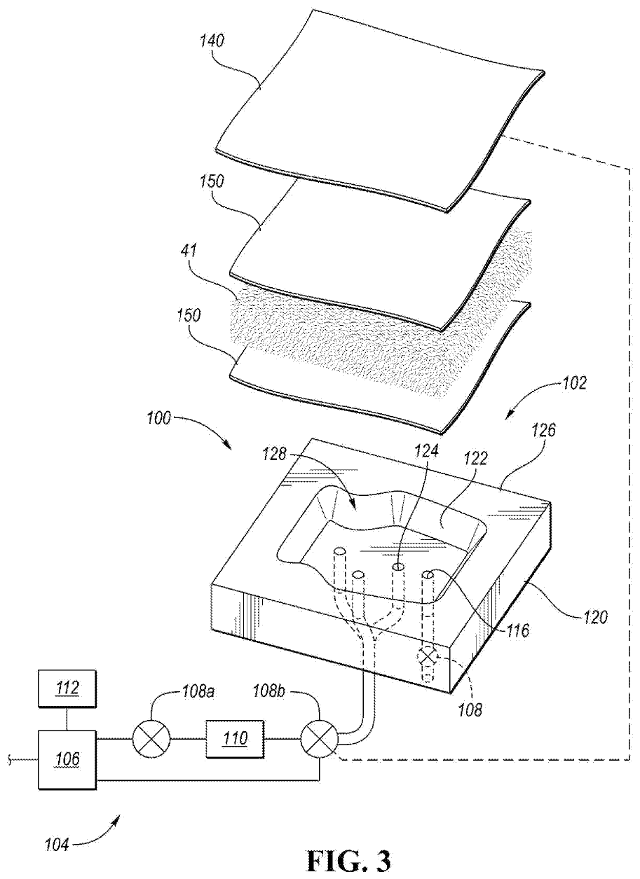

FIGS. 3-6 illustrate various systems for shaping and/or forming a cushion 40 from a cushion blank 41. Although the systems are described with respect for use in forming a cushion, other vehicle interior components, stranded mesh material members, and products may likewise be formed using the systems and associated methods from an associated blank.

FIG. 3 illustrates a system 100 for shaping or forming the cushion 40 from a cushion blank 41. A cushion blank 41 is positioned within the system 100 to shape the cushion blank 41 into the desired final shape and with the features, e.g. recesses, contours, etc., for the cushion 40. The cushion blank 41 is formed from a consolidated filament structure or stranded mesh material member as described above after the material has been cooled and cut into blank form.

The system 100 has a tool assembly 102. The tool assembly 102 is in fluid communication with one or more fluid systems 104. Each fluid system 104 has a fluid flow device 106, or fluid transfer device, such as a pump, vacuum, and/or fan, one or more valves 108, and a heater 110. The fluid system 104 may circulate fluid, such as air, or a liquid to the tool assembly 102, with the flow controlled via a controller 112. The fluid system 104 may be configured to draw a vacuum on the tool assembly 102, and/or may provide pressurized fluid flow to the tool assembly 102. In the non-limiting example shown, the fluid system(s) 104 provides air to the tool assembly 102, although other fluids, including gas or liquid are also contemplated. The fluid transfer device may in fluid communication with ambient or environmental air as shown, or alternatively, may be in fluid communication with a reservoir or used in a closed loop system. In some embodiments, the fluid system 104 may additionally have an outlet 116 for fluid flow out of the tool assembly, and further, flow through the outlet 116 may be controlled via another valve 108. In other embodiments, the fluid system 104 is provided without the outlet 116 from the tool assembly.

Referring to FIG. 3, the tool assembly 102 of the system 100 has a tool 120, which has a forming surface 122 defining at least one fluid port 124 therethrough. Although the tool assembly is described with only a single tool 120, multiple tools 120 may be used, e.g. to provide undercut features, or for larger cushions or more complex geometries. In some examples, the forming surface 122 defines a cavity 128 shaped to form a cushion member from the blank 41. In other examples, the forming surface 122 may be shaped as a planar and/or convex surface, and in some embodiments, the convex surface(s) may provide for localized creation of shapes in the cushion 40. The forming surface 122 is shaped to form various shapes into the cushion 40 from the blank 41, including concave, convex, or other complex shapes; channels, recesses, curves, chamfers, stepped corners or regions, or the like. The cavity 128 may further be sized to be smaller in volume than the blank 41, such that the tool assembly 102 compresses the blank 41 in the tool assembly, which may provide different localized densities in different regions in the cushion 40. In other words, the blank 41 may be oversized relative to the cavity 128. The variation in localized densities in the resulting cushion 40 may be advantageous, e.g. by providing an increased density in a thinner section or region.

The fluid system 104 is in fluid communication with the one or more fluid ports 124 as shown, e.g. for circulating air through the tool assembly 102, e.g. for pulling a vacuum and/or for providing pressurized fluid flow. The fluid system 104 and fluid ports 124 may additionally or alternatively be used to deliver fluid (e.g. air) for heating to cooling the blank 41 or member within the tool assembly, and/or for preheating the tool assembly. In the example shown, first and second valves 108a, 108b are used to connect the fluid transfer device 106 and the heater 110 to the fluid port(s) 124 of the tool assembly 102; however, other valving arrangements and fluid circuit layouts are also contemplated.

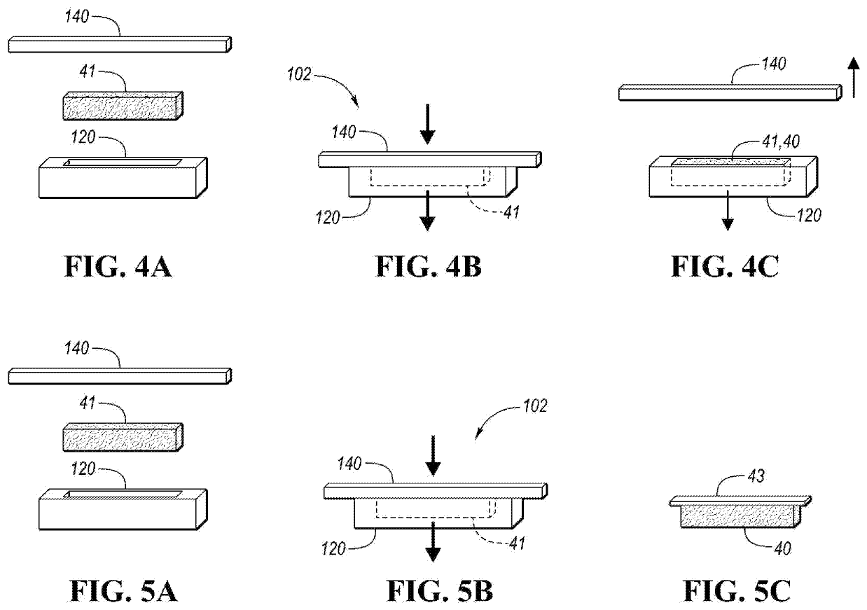

The tool 120 has a mating surface 126 that cooperates with a flexible sheet 140 to close the tool assembly. The flexible sheet 140 may be a solid sheet or impermeable, e.g. where fluid such as air or water does not cross the layer. In some examples, and for use with the system as shown in FIG. 4, the flexible layer 140 may be formed from a plastic, polymer or other layer or membrane.

In some examples, and for use with the system shown in FIG. 5, the flexible sheet 140 (or an additional optional flexible layer or sheet 150) is formed from a material that is the same as or is substantially similar or compatible with the cushion blank 41. In one non-limiting example, the flexible layer 140, 150 and the cushion blank 41 are both formed from a polymeric material such as LLDPE. For purposes of the disclosure, materials that are substantially similar or compatible with one another have similar softening temperatures, e.g. glass temperatures or transition temperatures, e.g. within 1%, 2%, 5%, 10%, and/or 15% of the stated temperature, such that the flexible sheet(s) 140, 150 and the stranded mesh material member blank 41 soften and are able to directly bond or fuse to one another, e.g. without the use of an additional adhesive or material. In other examples, an additional adhesive material may be provided between the blank 41 and layer 140, 150 to provide the bond via only the adhesive, or to provide a stronger bond in conjunction with the direct bond between the blank 41 and the associated layer 140, 150.

One or more additional flexible layer or sheets 150 may be positioned within the tool assembly 102, between the blank 41 and the tool 120 and/or between the blank 41 and the flexible layer 140. The additional flexible layers 150 are formed from a material that is the same as or substantially similar or compatible with the material of the blank 41 such that they bond to the blank 41 when the cushion 40 is being formed in the system 100, and from a skin on one or more sides of the cushion 40. The additional flexible layer 150 may be solid and non-permeable and/or may be provided with one or more apertures. To the extent that the additional flexible layer is positioned between the blank and any fluid ports 124 on the tool 120, the flexible layer 150 may be provided with at least sufficient apertures positioned to allow fluid to circulate past the layer 150 and through the blank 41 in the tool 102. To the extent that the flexible layer 150 has any apertures and needs to be solid or non-permeable for use on the cushion 40, the layer 150 may be subsequently sealed after removal from the tool assembly 102, e.g. via a patch or the like.

Referring back to FIG. 3, the controller 112 is programmed or controlled to selectively fluidly couple the heater 110 to the tool assembly 102 to provide fluid to the tool assembly at a first temperature to soften a blank 41 and/or a flexible sheet therein, and selectively fluidly couple the fluid flow device 106 to the tool assembly to move the flexible sheet 140 towards the cushion blank 41 to form a cushion 40 using the tool assembly 102. The controller 112 may further circulate ambient temperature air, or cooler air or fluid through the tool assembly to set or harden the cushion 40 before removal from the tool assembly 102.

As the blank 41 is formed from a stranded mesh material and is porous, the fluid flow via the fluid system 104, e.g. vacuum drawn on the tool assembly or pressurized fluid provided to the tool assembly, flows through the stranded mesh material of the blank 41 and may convectively heat or cool the filaments and strands internally in the blank 41, as well as the strands along the outer surfaces of the blank 41.

In other embodiments, the flexible sheet 140 may be provided as a bladder that cooperates with the tool 120 to enclose the cavity, with the bladder in fluid communication with the fluid system 104 for circulation of fluid therethrough, e.g. via an optional conduit to the flexible sheet 140 as a bladder. The fluid system 104 may be fluid communication with the tool and/or the flexible sheet 140 as a bladder in this example.

The controller 112 of the system 100 is configured to control the fluid transfer device(s) 106, the valves 108, and the heater 110 to selectively fluidly couple the heater 110 to tool assembly 102 to circulate fluid to the cavity 128 at a first temperature, and selectively fluidly decouple the tool assembly 102 from the heater 110 to circulate fluid through the cavity 128 at a second temperature less than the first temperature. To the extent that the tool assembly 102 has valves 108 for an outlet 116, the controller 112 may control the position of the outlet valves to retain fluid or a vacuum level within the cavity 128 or vent the cavity. For example, the controller 112 may close the valve 108 for the outlet 116 when providing fluid at the first temperature, and open the valve 108 for the outlet 116 when providing fluid at the second temperature, or vice versa. The controller 112 may further at least partially open or at least partially close the valves 108 while providing fluid at the first temperature and/or second temperature to control the temperature profile within the cavity 128. The system 100 may have various sensors, such as temperature sensors, for use in controlling the flow through the tool assembly 102. The temperature thresholds for control of the system 100 may be set based on a softening temperature of the material for the filaments of the blank 41, any additional flexible sheets or layers in the tool assembly, and/or the flexible layer 140. In one example, the first temperature is set at an offset above the softening temperature, e.g. twenty to thirty degrees Celsius above the softening temperature. In another example, the second temperature is set at an offset below the softening temperature, and may be provided at ambient temperature. The controller 112 may further control the time that the fluid is provided into the cavity 128 at the first temperature, the time that the fluid is provided to the cavity 128 at the second temperature, the flow rate of the fluid, and/or the ramp on the temperature of the fluid in order to further control the shaping process for the blank 41.

The softening temperature may refer to the glass transition temperature of the material, and be less than the melting point, thereby allowing the filaments to soften and change shape of the filament and the blank 41, without completely melting the filaments and losing the overall filament structure and porosity in the blank 41 and resulting cushion. Depending on the material for the flexible layer, the softening temperature may likewise soften the flexible layer, allowing the softened filaments to directly bond to the layer to connect the two.

In various examples, a method is provided for use with the system 100 and controller 112 and to form a cushion 40 from a cushion blank 41 or a stranded mesh material blank 41. The method may have additional steps or fewer steps than is described below, and the steps may be performed in another order, and/or may be performed in series or in parallel (e.g. at the same time) as one another.

In a first step, the blank is inserted into a cavity 128 of a tool assembly 102 shaped to form a cushion member. In some embodiments, the cushion may additionally or alternatively referred to as a product, a contoured unitary mesh product, consolidated filament structure, filament structure, mesh, extruded material, thermoplastic cushion, mesh cushion, seat cushion, or cushion; and filaments or strands may be used herein to refer to the generally linear polymeric units (although they may be looped, fused or bonded together to form a mesh-like structure. The blank 41 may be compressed by the tool 120 as the size of the blank 41 may be larger than the cavity 128, e.g. the volume of the blank may be greater than the volume of the cavity. In various examples, the blank 41 may be compressed to different degrees in different regions based on the size and shape of the blank 41 relative to the size and shape of the cavity 128.

In a second step, one or more flexible sheets, such as sheet 140 are placed into the tool assembly 102. In some embodiments, one or more additional flexible sheets 150 may be placed into the tool assembly 102.

Note that the tool 120 may be preheated prior to insertion of the blank 41 and/or the sheets 140, 150 into the tool assembly, or any heating to the tool 120 may occur only after the blank 41 is inserted via the fluid flow at the first temperature. Additionally, the sheet 140 and/or any sheets 150 may be heated prior to placement into the tool assembly 102.

In a third step, the cushion blank 41 and/or the flexible sheet 140 is heated and softened. During the third step, any optional additional sheets 150 may additionally be heated and softened. In some embodiments, the controller 112 operates the fluid transfer device(s) 106, the valves 108, and the heater(s) 110 to circulate fluid above a first temperature threshold into the cavity 128 of the tool assembly 102 thereby softening the blank 41 and conforming a shape of the blank to the forming surfaces 122. The controller 112 may further control any valves 108 for any outlets 116, e.g. to a closed position to generally retain fluid within the cavity 128, and/or to an open position to vent the cavity 128.

In a fourth step, the controller 112 then controls the fluid transfer device 106, and the valves 108 to circulate the fluid through the tool assembly 102 to move or force the flexible sheet 140 towards the cushion blank 41 to form a cushion member 40. In some embodiments, a vacuum may be drawn on the tool assembly 102, e.g. at a pressure below ambient pressure, thereby pulling the flexible sheet 140 towards the cushion blank 41 in a vacuum forming process. In other embodiments, fluid may be circulated at a positive pressure, e.g. at a pressure above ambient pressure, in the tool assembly 102 and system to force or press the flexible sheet 140 towards the cushion blank 41 in a positive pressure forming process. In other embodiments, a combination of a vacuum forming process and a pressure forming process may be used, e.g. with a vacuum drawn on the cavity and through the blank 41 to draw the sheet 140 towards the blank, and positive fluid pressure applied to the sheet 140 on the side opposite the blank 41 to press the sheet 140 onto the blank 41, which may require additional fluid transfer devices, or a second fluid system, both of which are contemplated by the present disclosure.

In a fifth step, the controller 112 operates the fluid transfer device(s) 106, and the valves 108 to circulate fluid below a second temperature threshold into the cavity 128 of the tool assembly 102 thereby cooling the blank 41 and setting the blank to the shape of the forming surface 122 to form the cushion member 40. The controller 112 may further control any valves 108 for any outlets 116, e.g. to a closed position to generally retain fluid within the cavity 128, and/or to an open position to vent the cavity 128. In various examples, the first temperature threshold is greater than a softening temperature of the blank 41, and the second temperature threshold is less than a softening temperature of the blank 41. In a further example, the fluid may be provided to the tool assembly at an ambient temperature during the fifth step. In some examples, the method and system 100 are operated without the fifth step, and the blank cools and sets without the fluid system 104 circulating fluid through the blank 41.

The second step may be a first temperature cycle for the blank 41 to soften and shape the blank 41 to the shape defined by the forming surfaces, and the fifth step may be a second temperature cycle for the blank to set the shape of the blank 41. In some embodiments, the second and fifth steps may act as temperature cycles to likewise soften and set the flexible sheets 140 and/or flexible sheets 150 to bond the flexible sheets to the blank 41 and form an integrated skin.

In a sixth step, the cushion 40 is removed from the tool assembly 102 and system 100. To the extent that the flexible sheet 140 is not bonded to the member 40 via the method, the flexible sheet 140 is also removed from the cushion member 40.

In various examples, the first through sixth steps may be performed sequentially.

The cushion 40 may provide a vehicle interior component and/or a seating cushion, e.g. Seat bottoms, backs, bases, head restraints, headrests, or bolsters may be used herein to refer generally to any component, region or portion of a vehicle interior component, a seat assembly, vehicle seat, or chair, or may provide another product as shaped stranded mesh material member, with or without one or more skins formed by additional flexible sheets 150.

The method may further include attaching the cushion member to a frame of a seat assembly, such as vehicle seat assembly 20, to provide a cushion therefor. The method and system may result in a vehicle interior component formed by the cushion 40 with a stranded mesh material member comprising a concave surface and/or a convex surface. In some embodiments, the vehicle interior component and cushion additionally have a flexible layer bonded or fused to the concave surface and/or the convex surface of the stranded mesh material member, e.g. via sheet 140 and/or additional sheet 150.

In one example and with reference to FIG. 4, a vacuum forming process is illustrated for the system 100 and method. Additional details of the system 100 and method are described above. The blank 41 is positioned into the tool assembly 102 and tool 120 and the flexible sheet 140 is provided to cooperate with the tool 120 to enclose the blank 41 in the tool assembly, as generally shown in in FIG. 4A and FIG. 4B. The blank 41 may be positioned to be between the tool 120 and the sheet 140. In some embodiments, additional flexible sheets 150 to bond to the blank 41 may additionally be positioned within the tool assembly 102, but are not shown for this example specifically.

In FIG. 4B, the fluid system 104 circulates fluid through the tool assembly 102 as shown by the “in” arrow above a first temperature threshold to soften the blank 41. In FIG. 4B, the fluid system 104 also circulates fluid through the tool assembly 102 as shown by the “out” arrow to draw a vacuum via the blank 41 and onto the flexible sheet 140 to draw the blank 41 into the tool 120 such that the blank conforms to the forming surfaces 122. In FIG. 4C, the fluid system 104 also circulates fluid below the second temperature threshold and through the tool assembly 102 as shown by the “in” arrow to cool and set the blank 41. Also in FIG. 4C, the fluid system 104 releases the vacuum on the tool assembly 102 such that the flexible sheet 140 can be removed, and the formed cushion 40 may also be removed from the tool assembly 102.

In another example, and with reference to FIG. 5, another vacuum forming process is illustrated for the system 100 and method. Additional details of the system 100 and method are described above. The blank 41 is positioned into the tool assembly 102 and tool 120 and the flexible sheet 140 is provided to cooperate with the tool 120 to enclose the blank 41 in the tool assembly, as generally shown in in FIG. 5A and FIG. 5B. The blank 41 may be positioned to be between the tool 120 and the sheet 140. In some embodiments, additional flexible sheets 150 to bond to the blank 41 may additionally be positioned within the tool assembly 102, but are not shown for this example specifically.

In FIG. 5B, the fluid system 104 circulates fluid through the tool assembly 102 as shown by the “in” arrow above a first temperature threshold to soften the blank 41 and to soften the flexible sheet 140. In FIG. 5B, the fluid system 104 also circulates fluid through the tool assembly 102 as shown by the “out” arrow to draw a vacuum via the blank 41 and onto the flexible sheet 140 to draw the blank 41 into the tool 120 such that the blank conforms to the forming surfaces 122. During the heating and vacuum steps, the flexible skin 140 is bonded or fused to the blank 41 to form an integrated skin. Alternatively or additionally, an adhesive may be provided to bond the sheet 140 to the blank 41. Subsequent to FIG. 5B, and in some embodiments, the fluid system 104 also circulates fluid below the second temperature threshold and through the tool assembly 102 to cool and set the blank 41 before it is removed from the tool assembly 102. FIG. 5C illustrates the formed cushion 40 with an integrated skin after it has been removed from the tool assembly 102.

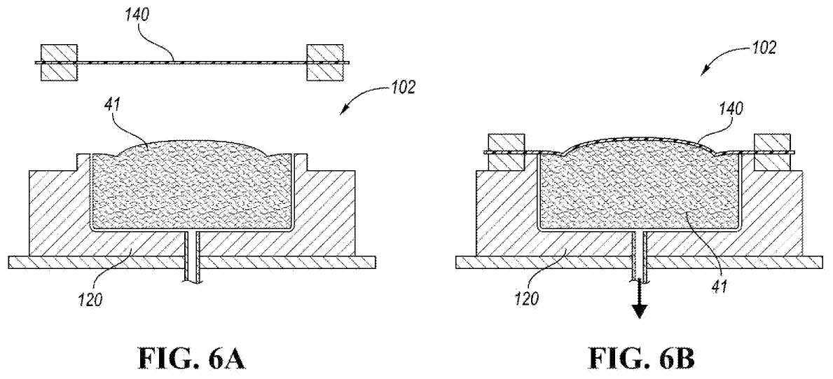

In a yet another example, and with reference to FIG. 6, vacuum and positive pressure forming process is illustrated for the system 100 and method. Additional details of the system 100 and method are described above. In FIG. 6A, the blank 41 is positioned into the tool assembly 102 and tool 120 and the flexible sheet 140 is provided to cooperate with the tool 120 to enclose the blank 41 in the tool assembly. The blank 41 may be positioned to be between the tool 120 and the sheet 140. In some embodiments, additional flexible sheets 150 to bond to the blank 41 may additionally be positioned within the tool assembly 102, but are not shown for this example specifically. The sheet 140 may be heated prior to or when it is placed onto the blank 41. In FIG. 6B, the fluid system 104 may circulate fluid through the tool assembly 102 above a first temperature threshold to soften the blank 41 and to soften the flexible sheet 140 and/or sheets 150.

In FIG. 6B, the fluid system 104 circulates fluid through the tool assembly 102, and may draw a vacuum on the blank 41 via the tool 120, and/or may provide positive pressurized fluid onto the side of the flexible sheet 140 opposite to the blank 41. In some embodiments, and as shown by the “out” arrow, the fluid system 104 circulates fluid to a vacuum via the blank 41 and onto the flexible sheet 140 to draw the blank 41 into the tool 120, and to draw the flexible sheet 140 onto the surface of the blank 41 such that the blank conforms to the forming surfaces 122 and the sheet 140 conforms to the blank 41. Additionally or alternatively, and in some embodiments, the fluid system 104 circulates fluid as positive pressure onto the flexible sheet 140 to press the flexible sheet 140 onto the upper surface of the blank 41 such that the blank conforms to the forming surfaces 122 and the sheet 140 conforms to the blank 41.

During the heating and vacuum and/or positive pressure steps, the flexible skin 140 may be bonded or fused to the blank 41 to form an integrated skin. Alternatively or additionally, an adhesive may be provided to bond the sheet 140 to the blank 41. Subsequent to FIG. 6B, and in some embodiments, the fluid system 104 also circulates fluid below the second temperature threshold and through the tool assembly 102 to cool and set the blank 41 before it is removed from the tool assembly 102.

FIGS. 3-6 illustrate various systems and methods for forming and assembling stranded mesh material members according to various non-limiting embodiments. In some embodiments, a stranded mesh material member is formed into a desired shape in a mold or tool assembly from a stranded mesh material member blank without bonding a separate skin or layer to the extruded mesh filament structure. The stranded mesh material member blank is inserted into the tool, the mold is closed, fluid, such as hot air, is provided to the cavity to heat and soften the piece, fluid flow is circulated, e.g. by pulling a vacuum or using pressurized fluid such as air, to force the softened piece against the tool to reshape the member, and/or fluid such as air is then provided to cool and harden the member to set its shape, the vacuum is released, the tool is opened, and the member is removed from the tool. In some examples, the tool assembly may comprise a single tool with a forming surface, and a flexible sheet, e.g. for vacuum and/or positive pressure forming. The flexible sheet may be a single film, or may be a bladder through which the fluid is circulated to selectively inflate the bladder and exert a force on the blank to form the member.

Additionally or alternatively, and in some embodiments, a flexible layer or skin may be added to the stranded mesh material member in the tool assembly. The flexible layer may be non-permeable or solid in some examples, and may be provided from a material that is the same as or is substantially similar or compatible with the stranded mesh material member. In some examples, the stranded mesh material blank is positioned between a forming surface of a tool and the layer, and fluid is circulated, e.g. by drawing a vacuum or providing pressurized fluid to force the stranded mesh material member into the shape defined by the tool assembly. During the process, the flexible layer is bonded to the stranded mesh material member as heated fluid or air is provided into the tool assembly at a temperature above a softening temperature of the stranded mesh material member and the layer.

Clause 1. A method in combination with, or without, any one or more of the successive clauses, is provided. The method includes inserting a stranded mesh material blank into a tool assembly, placing a flexible sheet into the tool assembly, and heating and softening the stranded mesh material blank and/or the flexible sheet. The method also includes circulating fluid through the tool assembly, thereby moving the flexible sheet towards the stranded mesh material blank to form a stranded mesh material member; and removing the stranded mesh material member from the tool assembly.

Clause 2. The method of any of the preceding or successive clauses wherein circulating fluid further comprises drawing a vacuum on the flexible sheet within the tool assembly and via the stranded mesh material blank.

Clause 3. he method of any of the preceding or successive clauses wherein circulating fluid further comprises directing pressurized fluid on the flexible sheet.

Clause 4. The method of any of the preceding or successive clauses wherein the flexible sheet comprises a non-permeable layer.

Clause 5. The method of any of the preceding or successive clauses wherein heating and softening the stranded mesh material blank and/or the flexible sheet further comprises circulating heated fluid through the blank.

Clause 6. The method of any of the preceding or successive clauses wherein heating and softening the stranded mesh material blank and/or the flexible sheet further causes bonding of the flexible sheet to the blank and forming a skin on the member.

Clause 7. The method of any of the preceding or successive clauses further comprising cooling the stranded mesh material member within the tool assembly to set the shape prior to removing the stranded mesh material member from the tool assembly.

Clause 8. The method of any of the preceding or successive clauses further comprising removing the flexible sheet from the stranded mesh material member when removing the stranded mesh material member from the tool assembly.

Clause 9. The method of any of the preceding or successive clauses wherein the stranded mesh material member is one of a vehicle interior component and a seating cushion.

Clause 10. The method of any of the preceding or successive clauses wherein the tool assembly comprises a concave forming surface to receive and shape the blank.

Clause 11. The method of any of the preceding or successive clauses wherein the tool assembly comprises a convex forming surface to shape the blank.

Clause 12. The method of any of the preceding or successive clauses further comprising positioning another flexible sheet into the tool assembly, with the stranded mesh material blank positioned between the flexible sheet and the another flexible sheet.

Clause 13. The method of any of the preceding or successive clauses further comprising forming the stranded mesh material blank as a polymeric mesh comprising a plurality of integrated polymeric strands.

Clause 14. The method of any of the preceding or successive clauses further comprising attaching the mesh member to a frame of a seat assembly to provide a cushion therefor.

Clause 15. A system in combination with, or without, any one or more of the successive clauses, comprises a tool assembly comprising a forming surface and one or more fluid ports, a fluid flow device connected to the one or more fluid ports, and a heater in fluid communication with the tool assembly. The system also comprises a controller to selectively fluidly couple the heater to the tool assembly to provide fluid to the tool assembly at a first temperature to soften a stranded mesh material blank and/or a flexible sheet therein, and selectively fluidly couple the fluid flow device to the tool assembly to move the flexible sheet towards the stranded mesh material blank to form a stranded mesh material member.

Clause 16. The system of any of the preceding or successive clauses wherein the heater is fluidly connected to the one or more fluid ports via a first valve.

Clause 17. The system of any of the preceding or successive clauses wherein the fluid flow device is fluidly connected to the one or more fluid ports via a second valve.

Clause 18. A vehicle interior component in combination with, or without, any one or more of the successive clauses, comprises a stranded mesh material member comprising a concave surface and/or a convex surface, and a flexible layer bonded to the concave surface and/or the convex surface of the stranded mesh material member.

Clause 19. The vehicle interior component of any of the preceding or successive clauses wherein each of the flexible layer and the stranded mesh material member comprise the same material and/or a compatible material.

Clause 20. The vehicle interior component of any of the preceding or successive clauses wherein the flexible layer is impermeable.

Clause 21. Any one of the preceding clauses 1-20 in any combination.

While exemplary embodiments are described above, it is not intended that these embodiments describe all possible forms according to the disclosure. In that regard, the words used in the specification are words of description rather than limitation, and it is understood that various changes may be made without departing from the spirit and scope of the disclosure. Additionally, the features of various implementing embodiments may be combined to form further embodiments according to the disclosure.

1. A method comprising:
inserting a stranded mesh material blank into a tool assembly;
placing a flexible sheet into the tool assembly;
heating and softening the stranded mesh material blank and/or the flexible sheet;
circulating fluid through the tool assembly, thereby moving the flexible sheet towards the stranded mesh material blank to form a mesh member; and
removing the mesh member from the tool assembly.

2. The method of claim 1 wherein circulating fluid further comprises drawing a vacuum on the flexible sheet within the tool assembly and via the stranded mesh material blank.

3. The method of claim 1 wherein circulating fluid further comprises directing pressurized fluid on the flexible sheet.

4. The method of claim 1 wherein the flexible sheet comprises a non-permeable layer.

5. The method of claim 1 wherein heating and softening the stranded mesh material blank and/or the flexible sheet further comprises circulating heated fluid through the blank.

6. The method of claim 1 wherein heating and softening the stranded mesh material blank and/or the flexible sheet further causes bonding of the flexible sheet to the blank and forming a skin on the mesh member.

7. The method of claim 1 further comprising cooling the mesh member within the tool assembly to set the shape prior to removing the mesh member from the tool assembly.

8. The method of claim 1 further comprising removing the flexible sheet from the mesh member when removing the mesh member from the tool assembly.

9. The method of claim 1 wherein the mesh member is one of a vehicle interior component and a seating cushion.

10. The method of claim 1 wherein the tool assembly comprises a concave forming surface to receive and shape the blank.

11. The method of claim 1 wherein the tool assembly comprises a convex forming surface to shape the blank.

12. The method of claim 1 further comprising positioning another flexible sheet into the tool assembly, with the stranded mesh material blank positioned between the flexible sheet and the another flexible sheet.

13. The method of claim 1 further comprising forming the stranded mesh material blank as a polymeric mesh comprising a plurality of integrated polymeric filaments, wherein the plurality of filaments are looped and bonded to each other.

14. The method of claim 1 further comprising attaching the mesh member to a frame of a seat assembly to provide a cushion therefor.

15. A system comprising:
a tool assembly comprising a forming surface and one or more fluid ports;
a fluid flow device connected to the one or more fluid ports;
a heater in fluid communication with the tool assembly; and
a controller to selectively fluidly couple the heater to the tool assembly to provide fluid to the tool assembly at a first temperature to soften a stranded mesh material blank and/or a flexible sheet therein, and selectively fluidly couple the fluid flow device to the tool assembly to move the flexible sheet towards the stranded mesh material blank to form a mesh member.

16. The system of claim 15 wherein the heater is fluidly connected to the one or more fluid ports via a first valve.

17. The system of claim 16 wherein the fluid flow device is fluidly connected to the one or more fluid ports via a second valve.

18. A vehicle interior component comprising:
a stranded mesh material member comprising a concave surface and/or a convex surface; and
a flexible layer bonded to the concave surface and/or the convex surface of the stranded mesh material member.

19. The vehicle interior component of claim 18 wherein each of the flexible layer and the stranded mesh material member comprise the same material and/or a compatible material.

20. The vehicle interior component of claim 18 wherein the flexible layer is impermeable.
